(19) United States
(12) Patent Application Publication
(10) Pub. No.: US 2014/0111232 A1
(43) Pub. Date: Apr. 24, 2014

(54) METHOD FOR DETECTING A ROTATION OF A ROTOR OF A GENERATOR

(71) Applicants: Thomas Koss, Reutlingen (DE); Arnold Engber, Hoesbach (DE)

(72) Inventors: Thomas Koss, Reutlingen (DE); Arnold Engber, Hoesbach (DE)

(21) Appl. No.: 14/111,508

(22) PCT Filed: Feb. 9, 2012
(86) PCT No.: PCT/EP2012/052204

§ 371 Date: Dec. 16, 2013

(30) Foreign Application Priority Data
Apr. 13, 2011 (DE) 102011007331.0

(51) Int. Cl. G01B 7/30

(52) U.S. Cl. CPC G01B 7/30
USPC 324/713; 324/71.1

(57) ABSTRACT

A method for detecting a rotation of a rotor of a generator, which includes measuring the voltage induced in the rotor for the generator voltage in the case of an emergency start with an inactive closed-loop controller; and detecting the rotor rotation with the aid of the induced voltage. When a rotation is detected, the control circuit is activated and the rotation is determined from the phase voltage.

### BACKGROUND INFORMATION

To detect a rotation or a rate of rotation of a rotor of a generator, and for a new start of the generator, a phase signal, e.g., a phase voltage, is usually measured at a phase pickoff point of the generator. However, an analyzable amplitude is required in order to be able to determine an alternating component of the phase signal, which, however, comes about only at higher rotational speeds.

The emergency start of the generator is meant to activate the controller in the event that no communication is taking place between a higher-level control unit and a closed-loop controller which actuates the generator. As a rule, an alternating component of the phase signal, which forms as a result of the remanence present in the rotor of the generator and the rotation of the rotor, is analyzed for this purpose. Depending on the remanence and the design of the generator, however, the alternating component attains an analyzable amplitude only at high rotational speeds. In order to allow an early activation of the closed-loop controller, the analysis of the phase signal must therefore take place with the appropriate sensitivity, but this is a complex process and reduces the robustness of the closed-loop controller with respect to interference.

To increase the sensitivity of a phase-signal analysis, the German Published Patent Appln. No 43 27 485 provides a circuit system in which the voltage of a phase is detected against ground, and a further phase of the generator is switched to ground via a resistor. This increases the measured voltage.

### SUMMARY

It is an object of the present invention to provide a concept for the efficient detection of a rotation of a rotor of a generator.

The present invention is based on the understanding that a rotary motion of a rotor of a generator is able to be detected in efficient manner by analyzing an excitation voltage in or at the excitation circuit of the generator. This is so because a voltage step of the excitation voltage is greater than a step of the phase signal, which allows for a more precise and advantageous voltage detection and thus a more precise detection of the rotary motion.

According to one aspect, the present invention relates to a method for detecting a rotation of a rotor of a generator, which includes the measurement of an excitation voltage in or at an excitation circuit of the generator, and a detection of the rotation of the rotor based on the measured excitation voltage. This advantageously makes it possible to detect a signal, and thus a rotary motion of the rotor, in efficient manner even at low rotational speeds, because the sensitivity of the detection of the rotary motion is advantageously increased considerably in comparison with a phase pickoff.

In one advantageous development, the alternating component of the excitation voltage is able to be measured. Measuring the alternating component allows a particularly precise detection of a rotary motion of the rotor.

According to one advantageous specific embodiment, the rotation of the rotor is detected only if the measured excitation voltage exceeds a predefined value. This advantageously improves the measuring reliability.

According to one advantageous specific embodiment, the generator includes a closed-loop controller for regulating a generator voltage; the closed-loop controller is able to be transferred into an active and an inactive state, especially into a standby mode, the excitation voltage being detecting in the inactive state. This makes it possible to detect the rotation of the rotor in an especially precise manner.

According to one advantageous specific development, a phase voltage is measured at a phase terminal of the generator in the active state, and the rotation of the rotor in the active state is optionally able to be detected on the basis of the measured phase voltage. This makes it possible to detect the rotation of the rotor in especially advantageous manner even if the excitation voltage is not analyzable.

According to one advantageous specific embodiment, the closed-loop controller is able to be activated, especially by a customer interface. This allows a flexible activation of the closed-loop controller in an especially advantageous manner.

According to one advantageous specific embodiment, the closed-loop controller is transferred into the active state when a rotation of the rotor is detected.

According to one advantageous specific embodiment, the excitation voltage is measured via a shunt resistance of the excitation circuit. This makes it possible to measure the excitation voltage in an especially uncomplicated manner.

According to one advantageous specific embodiment, the rotation of the rotor of the generator in an emergency start is detected on the basis of the excitation voltage. In this way the rotation of the rotor is able to be detected in an especially advantageous manner even if the excitation voltage is not analyzable. If the closed-loop controller is activated subsequently, then the rotation is able to be detected on the basis of a phase voltage at a phase terminal of the generator.

According to one further aspect, the present invention relates to a control device developed to execute the method for detecting a rotation of a rotor of a generator. To execute the method, the control device may be set up with the aid of programming technology.

### BRIEF DESCRIPTION OF THE DRAWINGS

FIG. 1 shows a diagram of a method for detecting a rotation of a rotor of a generator.

FIG. 2 shows an equivalent circuit diagram of an excitation circuit.

FIG. 3 shows exemplary voltage characteristics at the excitation circuit and at the phase pickoff.

### DETAILED DESCRIPTION

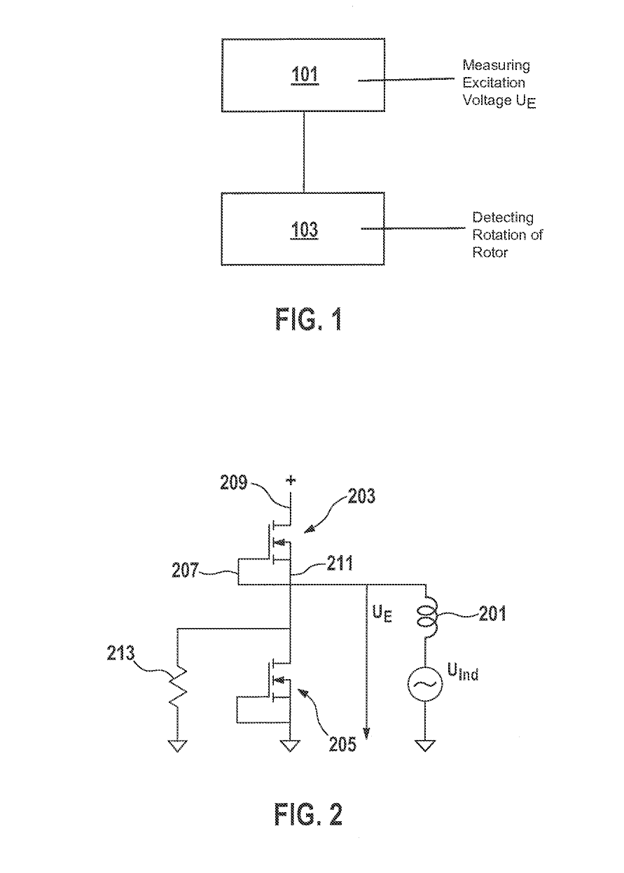

FIG. 1 shows a diagram of a method for detecting a rotation of a rotor of a generator according to one specific development. The method includes measuring 101 an excitation voltage U_{E} at an excitation circuit of the generator, and detecting 103 the rotation of the rotor based on measured excitation voltage U_{E}.

FIG. 2 shows an equivalent circuit diagram of an excitation circuit in an inactive state, e.g., in a standby state. The excitation circuit includes a rotor winding 201, a switch 203, which may be developed as field-effect transistor switch, for instance, and a free-wheeling diode 205, which, for example, may be realized by a suitable interconnection of a field-effect transistor switch. A gate terminal 207 of switch 203 is switched against a reference potential, e.g., ground, via rotor winding 201. For instance, a positive activation potential may be applied at a first terminal 209 of switch 203. A second terminal 211 of switch 203 is connected to the reference potential via free-wheeling diode 205. In addition, a bleed resistor 213 is provided, which is connected to second terminal 211 and to the reference potential.

Rotor winding 201 may have an inductance value of 150 mH and a resistance value of 1.8 Ohm.

Switch 203 and free-wheeling diode 205 are elements of a closed-loop controller which is able to be switched into an active and inactive state to regulate a voltage of a generator.

In the inactive state of the closed-loop controller, switch 203 and free-wheeling diode 205 are blocked. The excitation circuit is separated from the activation potential. If the rotor is rotating, a voltage U_{ind} is induced in rotor winding 201, whereupon corresponding excitation voltage U_{E} is measured via bleed resistor 213.

The constant component of excitation voltage U_{E} is determined via the cut-off current of switch 203 and free-wheeling diode 205, but is negligible due to the low resistance of the excitation circuit itself and the low reverse current.

The alternating component of excitation voltage U_{E} is restricted to a predefined negative value by free-wheeling diode 205. For example, the excitation voltage may be restricted to −0.45 V.

In case of an emergency start, the activation takes place by analyzing the exciter circuit voltage. If the closed-loop controller is activated, switch 203 is switched. The voltage in the exciter circuit now is no longer able to be analyzed. As a result, the rotation or the rotational speed of the rotor in the active mode may be ascertained from the phase voltage.

If the closed-loop controller is activated, the excitation current causes a large alternating component to form in the phase signal. In the active mode of the closed-loop controller, the phase signal may therefore be analyzed at a much lower sensitivity, in particular. The analysis of the phase signal can thus be set up to be much simpler and more robust. In the inactive mode of the closed-loop controller, on the other hand, the rotation of the rotor is able to be detected on the basis of the measured excitation voltage. The controller-ASIC may therefore be realized on a smaller surface, which leads to reduced costs. As an alternative, the analysis may be set up so that an activation already takes place at very low rotational speeds.

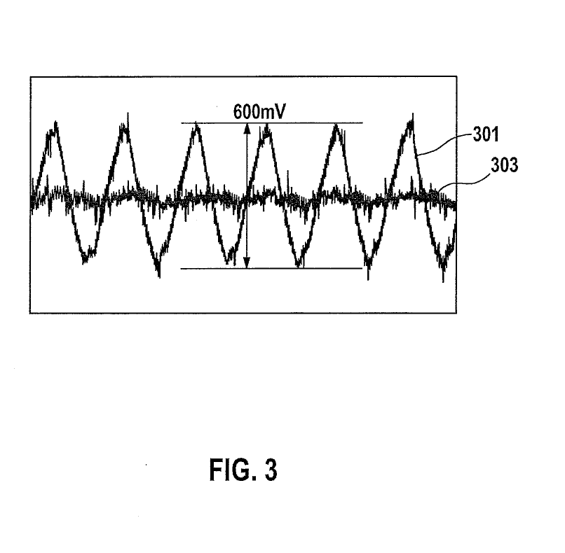

FIG. 3 shows a typical measured excitation voltage 301 while the rotor is rotating in the inactive state, and for comparison purposes, a corresponding phase voltage 303 at a phase pickoff at the same rotational speed. As shown quite clearly in FIG. 3, the voltage step of excitation voltage 301 is higher than the voltage step of phase voltage 303, which allows a more precise detection of a rotation of the rotor.

If the closed-loop controller is activated, switch 203 is switched. Then, the exciter circuit is excited in the generally known manner, by the activation potential. The rotary motion is able to be detected in the usual manner, via the phase pickoff, under these circumstances.

In an activation of the generator, an excitation voltage is normally applied first, and the generator is switched into the active state.

In an emergency start situation, in which no activation of the closed-loop controller takes place by an external signal or an external voltage, the activation of the closed-loop controller may be realized by analyzing the exciter circuit voltage in one exemplary embodiment according to the present invention. For instance, if the exciter circuit voltage induced by the rotary motion in the exciter circuit exceeds a predefined value, such as 5% or 10% of the voltage step, then the closed-loop controller is activated and switch 203 is switched. After the closed-loop controller has been activated, the voltage in the excitation circuit is no longer able to be analyzed, and the rotational speed is detected in the usual manner, by a phase pickoff. This is especially advantageous because at small rotational speeds, the amplitude of the alternating component of the voltage over the exciter circuit is considerably larger than the alternating component of the phase voltage. For the emergency start, it is therefore possible to analyze the voltage over the exciter circuit, while the voltage at the phase pickoff may be analyzed for the active mode.

The afore-described examples may be used not only in emergency start situations, but in general as well. For example, it is usually possible to dispense with an external signal for the activation, and the generator may be activated by the voltage detected in the exciter circuit.

1.-10. (canceled)

11. A method for detecting a rotation of a rotor of a generator, comprising:
measuring an excitation voltage at an exciter circuit of the generator; and
detecting the rotation of the rotor based on the measured excitation voltage.

12. The method as recited in claim 11, further comprising:
measuring an alternating component of the excitation voltage.

13. The method as recited in claim 11, wherein the detecting of the rotation of the rotor includes ascertaining whether the measured excitation voltage exceeds a predefined value.

14. The method as recited in claim 11, wherein the generator includes a closed-loop controller for regulating a generator voltage, the closed-loop controller being able to be transferred into an active state and into an inactive state, the excitation voltage being detected in the inactive state.

15. The method as recited in claim 14, wherein the inactive state corresponds to a standby mode.

16. The method as recited in claim 14, further comprising:
in the active state, measuring a phase voltage at a phase terminal of the generator, wherein the rotation of the rotor in the active state is detected with the aid of the measured phase voltage.

17. The method as recited in claim 14, wherein the closed-loop controller is able to be activated.

18. The method as recited in claim 17, wherein the closed-loop controller is able to be activated with the aid of a customer interface.

19. The method as recited in claim 14, wherein the closed-loop controller is transferred into the active state upon a detected rotation of the rotor.

20. The method as recited in claim 11, wherein the excitation voltage is measured parallel to the exciter circuit, via a bleed resistor.

21. The method as recited in claim 11, wherein the rotation of the rotor of the generator in an emergency start is detected with the aid of the excitation voltage.

22. A control device, comprising:
an arrangement for detecting a rotation of a rotor of a generator by:
measuring an excitation voltage at an exciter circuit of the generator, and
detecting the rotation of the rotor based on the measured excitation voltage.
